(19) United States
(12) Patent Application Publication
(10) Pub. No.: US 2007/0211397 A1
(43) Pub. Date: Sep. 13, 2007

(54) TAMPER RESISTANT GROUND FAULT CIRCUIT INTERRUPTER RECEPTACLE HAVING DUAL FUNCTION SHUTTERS

(76) Inventors: Stephen Sokolow, Locust Valley, NY (US); Edward Bazayev, Kew Gardens, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/674,061

(22) Filed: Feb. 12, 2007

Related U.S. Application Data
(60) Provisional application No. 60/772,169, filed on Feb. 10, 2006.

(51) Int. Cl. H02H 3/00

(52) U.S. Cl. 361/42

(57) ABSTRACT

An electrical receptacle having a tamper resistant mechanism is disclosed. In addition, a GFCI can optionally be configured to include the tamper resistant mechanism. Furthermore, the GFCI can be configured so that the GFCI engages the tamper resistant mechanism when the GFCI is tripped or reset. When the GFCI is tripped, the tamper resistant mechanism is engaged such that it prevents user access to the face terminals of the electrical receptacle. When the GFCI is reset the tamper resistant mechanism does not restrict access to the face terminals of the electrical receptacle. The tamper resistant mechanism has one or more shutter positioned with respect to one or more entry ports to the face terminals. The shutter positioning restricts the insertion of prongs of an electrical plug when the GFCI device of the electrical receptacle is tripped. The GFCI device is tripped when it detects a fault. The GFCI device of the electrical receptacle may be shipped in the tripped condition and cannot be reset if the GFCI device is reverse wired. Thus, the tamper resistant mechanism prevents access to a reverse wired GFCI.

This application claims priority pursuant to 35 U.S.C. 119(e) from U.S. Provisional Application having Application Ser. No. 60/772,169 filed Feb. 10, 2006.

### FIELD OF THE INVENTION

The present invention relates to circuit interrupters, and, more particularly, to a resettable ground fault circuit interrupter.

### BACKGROUND OF THE INVENTION

In an effort to prevent electrical shock, circuit interrupting devices are designed to interrupt power to various loads, such as household appliances and consumer electrical products. In particular, electrical building codes in many states require that electrical circuits in residential or commercial bathrooms and kitchens be equipped with circuit interrupting devices. Household appliances are typically connected to electrical receptacles having at least a hot terminal and neutral terminal; the terminals are usually implemented as receptacles to which an electrical plug of the household appliance is attached. When an appliance is working properly, the current used by the appliance flows from the hot terminal of the electrical receptacle through the appliance and back to the neutral terminal of the receptacle. When, however, a person uses an appliance in the rain or near a wet surface, an extra path may be created from the appliance through the person and the water to ground. Consequently the amplitude of the current flowing from the receptacle to the household appliance will not be equal to the amplitude of the current flowing from the appliance back to the neutral terminal of the receptacle; that is, part of the current has been diverted through the extra path. Therefore, an imbalance in the current flow is created; this imbalance is typically referred to as a ground fault

In general a circuit exists between a receptacle and a power source which provides power to the receptacle. A hot or phase wire from the power source is connected to a phase terminal of the receptacle and a neutral wire from the power source is connected to a neutral terminal of the receptacle. In may receptacles available today a circuit interrupting device, such as a ground fault circuit interrupter (GFCI) is placed in the receptacle and is connected to the phase and neutral terminals of the receptacle. Thus, when a household device is plugged into the receptacle the hot or phase wire extends from the power source to the receptacle through the GFCI to the household appliance. Also, a neutral connection extends from the household appliance to the receptacle through the GFCI and onto the power source's neutral terminal. As such, the GFCI is positioned as part of a circuit comprising the power source, the conductors connecting the power source to the receptacle, conductors connecting the receptacle to the appliance and conductors from the appliance to the receptacle and back to the power source. There is a switching mechanism within the GFCI that, when closed, allows the current in the circuit to flow from the power source through the GFCI to the appliance and from the appliance back to the receptacle through the GFCI and back to the power source. Circuit interrupting devices are designed to detect current imbalances and activate their switching mechanism so as to disconnect power from the receptacle thus disconnecting power from a household device plugged to the receptacle when a ground fault is detected.

Presently available circuit interrupting devices, such as the device described in commonly owned U.S. Pat. No. 4,595,894, use a trip mechanism to mechanically break an electrical connection between one or more input and output conductors of the circuit interrupting device. Such devices are resettable after the detection of a ground fault, for example. In particular, a trip mechanism is used to cause the mechanical breaking of the circuit. The trip mechanism includes a solenoid (or trip coil). As a feature to test the trip mechanism and circuitry used to sense faults, a test button is used to initiate a manual test of the GFCI. In addition, a reset button is used to reset the electrical connection between input and output conductors of the GFCI.

Electrical receptacles containing circuit interrupting devices (such as GFCIs) have a line side, which is connectable to an electrical power supply, and a load side, which is connectable to one or more loads (e.g., other receptacles). Where a circuit interrupting device includes a user accessible connection, the load side connection and user accessible connection are typically electrically connected to each other. An example of the user accessible connection is a two hole or three hole receptacle used for AC outlets; the connection is implemented as receptacle terminal in which a plug can be connected providing power to an electrical household device, for example. Wires from the power source are connected to the line side of the GFCI receptacle and wires from one or more loads (e.g., other receptacles) are connected to the load side of the GFCI receptacle. GFCI's are in widespread use today and are required in many jurisdictions by code. For example, in an effort to limit the exposure of children to electrical shock, the National Electrical Code (NEC) requires that in buildings where the predominant function of such buildings is to provide shelter for children (e.g., schools, nurseries, daycare facilities, hospitals, residential housing), tamper-resistant electrical receptacles and ground fault circuit interrupters (GFCI) should be incorporated within the electrical distribution systems within such residential or commercial buildings. While affording protection from a ground fault GFCI's can still be harmful. In particular, since a large percentage of electrical receptacles used in residential buildings are installed near the floor, a person, such as a young child or infant, for example, can insert small elongated articles into the cover apertures of the electrical receptacle. More particularly, if the child inserts an object made of conductive material including but not limited to a metal article, electrical shock may result. Another possibility is where an infant or a young child places his or her mouth over an electrical receptacle. Accordingly, a burn or shock may result when the child's wet mouth makes contact with one of the terminals; this is because a path is caused to exist from the hot receptacle terminal through the child to ground creating a ground fault. Ground fault circuit interrupters, however, only disconnect the power supplied to the circuit after a child has made contact with a conductor. Thus, without a tamper resistant electrical receptacle, a child may still experience an electrical shock.

Moreover, instances, occur where a circuit interrupting device is improperly connected to the external wires so that the load wires are connected to the line side connection and the line wires are connected to the load side connection; this is known as reverse wiring. In the event the circuit interrupting device is reverse wired, fault protection to the user accessible load connection may be eliminated, even if fault protection to the load side connection remains.

Numerous child-proof devices have been proposed or are commercially available which are directed to preventing a child from touching the sockets in a receptacle assembly or preventing a child from inserting or removing an electrical plug in or from a socket. Prior patents featuring safety electric receptacles have generally comprised attachments for the face plate of an electric receptacle featuring rotatable snap-on or sliding covers for the electric socket opening, such as disclosed by U.S. Pat. Nos. 3,639,886 and 3,656,083 in which the face plate attachments are manually moved for insertion and removal of the plug. These attachments, such as plastic receptacle caps, are generally designed to include plastic plates having a pair of wall receptacle aperture engaging blades. These plastic receptacle caps, however, can be unreliable and inefficient if misused. Children may be able to remove these receptacle caps if not properly installed.

Other patents, such as U.S. Pat. Nos. 2,552,061 and 2,610,999 feature overlying slotted slidable plates which must be manually moved to mate the overlying plate slots with the electric receptacle slots or openings for insertion and removal of the plug. Sliding shutter plates offer a different level of protection than receptacle caps. However, none of the sliding shutter plates that are on the market are UL listed. This is primarily due to the fact that they add extra layers of material between the plug prongs and the receptacle contacts.

Commonly owned, co-pending patent application, Ser. No. 10/690,776, filed Oct. 22, 2003 which is incorporated herein in its entirety by reference, describes a family of resettable circuit interrupting devices (e.g., GFCI receptacles) capable of preventing electric power from being accessible to users of such devices when these devices are reverse wired. Each device has a reset lockout mechanism that prevents the device from being reset when the device is not operating properly. When the device is not reset and if such device is reverse wired, no power is available to any user accessible receptacles and/or plugs located on the face of the devices. The device is preferably shipped in a trip condition, where no electrical connection exists between line and load terminals and no electrical connection exists between load and face terminals. Thus, in the trip condition the three terminals are electrically isolated from each other. If the device is wired in reverse, the device cannot be reset.

However, presently there are no devices within the family of resettable circuit interrupting devices having reverse wiring protection that includes a tamper-proof feature. Therefore, there is a need for a simple, effective, efficient, low-cost electrical receptacle that is tamper-proof and provides protection from reverse wiring.

The present invention is directed to overcoming, or at least reducing the effects of one or more of the problems set forth above.

### SUMMARY OF THE INVENTION

The present invention is directed to a receptacle coupled to a tamper-resistant mechanism comprising shutters. In a preferred embodiment, the shutters prevent access to the face terminals if an object is incorrectly inserted into the receptacle. In addition, the present invention can be incorporated into a GFCI which comprises a circuit interrupting mechanism. Furthermore, the shutters of the present invention may also operate in conjunction with the circuit interrupting portion of the receptacle to either permit or prevent access to the face terminals based on the state of the circuit interrupting device.

In this arrangement, the shutters prevent access to the face terminals when the circuit interrupting device is tripped and allow access when the circuit interrupting portion is not tripped. In a preferred embodiment the receptacle further comprises a reverse wiring protection circuit that operates in conjunction with the shutters to prevent access to the face terminals of the receptacle in the event the receptacle is reverse wired.

### BRIEF DESCRIPTION OF THE DRAWINGS

For a more complete understanding of an embodiment of the present invention and the advantages thereof, reference is now made to the following description taken in conjunction with the accompanying drawings in which like reference numbers indicate like features and wherein:

FIG. 1 is a perspective view of one embodiment of a ground fault circuit interrupting device in accordance with the present invention;

FIG. 2 is a front view of a portion of the GFCI device shown in FIG. 1, with the face portion removed;

FIG. 3 is an exploded perspective view of a face terminal, internal frames, load terminals and movable bridges in accordance with the present invention;

FIG. 4 is a perspective view of the arrangement of some of the components of the circuit interrupting portion of a GFCI device in accordance with the present invention;

FIG. 5 is a side view of FIG. 4;

FIG. 6 is a perspective view of the reset portion of a circuit interrupting device in accordance with the present invention;

FIG. 7 is an exploded perspective view of a lifter/latch assembly of a circuit interrupting device in accordance with the present invention;

FIG. 8 is a schematic of a sensing circuit in accordance with the present invention;

FIGS. 9-14 show the sequence of operation when a circuit interrupting device in accordance with the present invention is reset from a tripped state;

FIGS. 15-18 show the sequence of operation when a circuit interrupting device in accordance with the present invention is tripped while in a reset state;

FIG. 19 illustrates a front view of the electrical receptacle in accordance with an embodiment of the present invention;

FIG. 20 displays a cross-sectional view of FIG. 19 taken along Section line A-A where the cut extends through receptacle 100 when the pivoting locking rod is in the locked position;

FIG. 21 shows a cross-sectional view of FIG. 19 taken along Section line A-A where the cut extends through receptacle 100 when the pivoting locking rod is in the unlocked position;

FIG. 22 displays a perspective view of the electrical receptacle of an embodiment of the present invention with the cover removed;

FIG. 22A is a view of the device in FIG. 22 in accordance with another embodiment of the electrical receptacle where a solenoid is coupled to the locking rod instead of a mechanical arm;

FIG. 23 illustrates a front view of the electrical receptacle of FIG. 19 having cut line B-B;

FIG. 24 illustrates a cross-sectional view of FIG. 23 taken along Section line B-B where the cut extends through receptacle 100 when the pivoting locking rod is in the locked position;

FIG. 25 illustrates a front view of the electrical receptacle of FIG. 19 having cut line C-C;

FIG. 26 displays a cross-sectional view of FIG. 25 taken along Section line C-C where the cut extends through receptacle 100 when the pivoting locking rod is in the unlocked position;

FIG. 27 displays a cross-sectional view of FIG. 25 taken along Section line C-C where the cut extends through the cover 120 without cutting shutter 124 when the pivoting locking rod is in the locked position;

FIG. 27A is a view of the device in FIG. 27 in accordance with another embodiment of the device where an additional ramp element is added to decrease the angle on the shutter such that the shutter is supported on an angled platform as opposed to a flat platform;

FIG. 28 shows a cross-sectional view of FIG. 25 taken along Section line C-C where the cut extends through the cover 120 without cutting shutter 124 when the pivoting locking rod is in the locked position and wherein an electrical prong (not shown) is inserted causing the shutter 124 to tilt in an intermediate position;

FIG. 29 displays a cross-sectional view of FIG. 25 taken along Section line C-C where the cut extends through the cover 120 without cutting shutter 124 when the pivoting locking rod is in the locked position and wherein an electrical prong (not shown) is inserted causing the shutter 124 to tilt fully; and

FIG. 30 shows the underside view of FIG. 22 displaying how the pivoting locking rods fit into their respective slots.

### DETAILED DESCRIPTION OF PREFERRED EMBODIMENTS

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention is directed to an electrical receptacle coupled to tamper-resistant mechanism comprising shutters. In a preferred embodiment, the shutters prevent access to the face terminals if an object is incorrectly inserted into the receptacle. In addition, the present invention can be incorporated into a GFCI which comprises a circuit interrupting mechanism. Furthermore, the shutters of the present invention can also operate in conjunction with the circuit interrupting portion of the receptacle to either permit or prevent access to the face terminals based on the state of the circuit interrupting device.

In this arrangement, the shutters prevent access to the face terminals when the circuit interrupting device is tripped and allow access when the circuit interrupting portion is not tripped. In a preferred embodiment the receptacle further comprises a reverse wiring protection circuit that operates in conjunction with the shutters to prevent access to the face terminals of the receptacle in the event the receptacle is reverse wired.

I. GFCI Operation

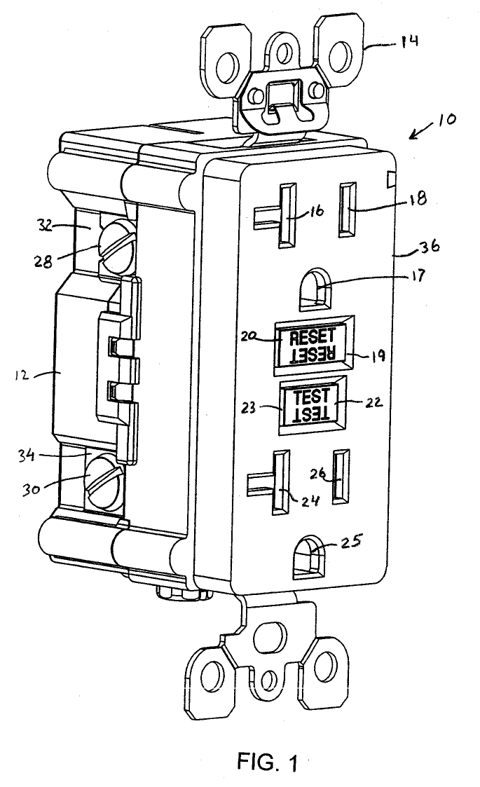

Turning now to FIG. 1, the GFCI device has a housing 12 to which a face or cover portion 36 is secured. The housing may optionally be integral with the face. The face portion 36 has entry ports 16, 18, 24 and 26 aligned with receptacles for receiving normal or polarized prongs of a male plug of the type normally found at the end of a household device electrical cord (not shown), as well as ground-prong-receiving openings 17 and 25 to accommodate three-wire plugs. The GFCI device also includes a mounting strap 14 used to fasten the device to a junction box.

A test button 22 may extend through opening 23 in the face portion 36 of the housing 12. The test button may be used to set the device 10 to a trip condition. The circuit interrupting portion, to be described in more detail below, is used to break electrical continuity in one or more conductive paths between the line and load side of the device. A reset button 20 forming a part of the reset portion may extend through opening 19 in the face portion 36 of the housing 12. The reset button is used to activate a reset operation, which reestablishes electrical continuity in the open conductive paths.

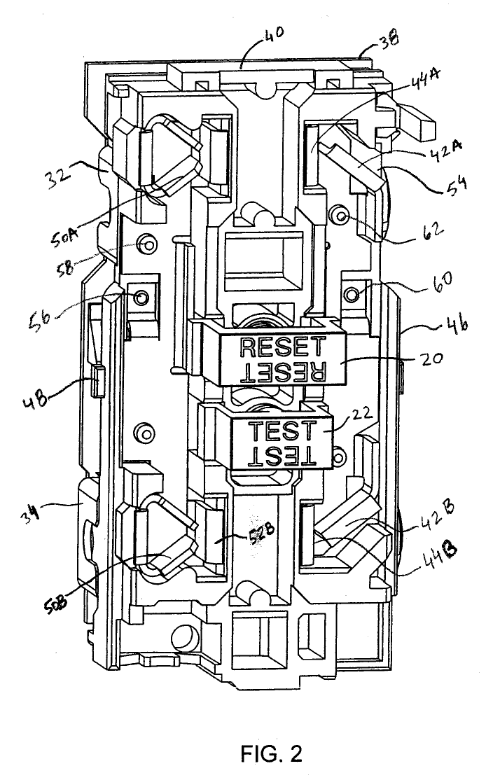

Still referring to FIG. 1, electrical connections to existing household electrical wiring are made via binding screws 28 and 30 where, for example, screw 30 is an input (or line) phase connection, and screw 28 is an output (or load) phase connection. Screws 28 and 30 are fastened (via a threaded arrangement) to terminals 32 and 34 respectively. However, the GFCI device can be designed so that screw 30 can be an output phase connection and screw 28 an input phase or line connection. Terminals 32 and 34 are one half of terminal pairs. Thus, two additional binding screws and terminals (not shown) are located on the opposite side of the device 10. These additional binding screws provide line and load neutral connections, respectively. It should also be noted that the binding screws and terminals are exemplary of the types of wiring terminals that can be used to provide the electrical connections. Examples of other types of wiring terminals include set screws, pressure clamps, pressure plates, push-in type connections, pigtails and quick-connect tabs. The face terminals as shown are implemented as receptacles configured to mate with male plugs. A detailed depiction of the face terminals is shown in FIG. 2.

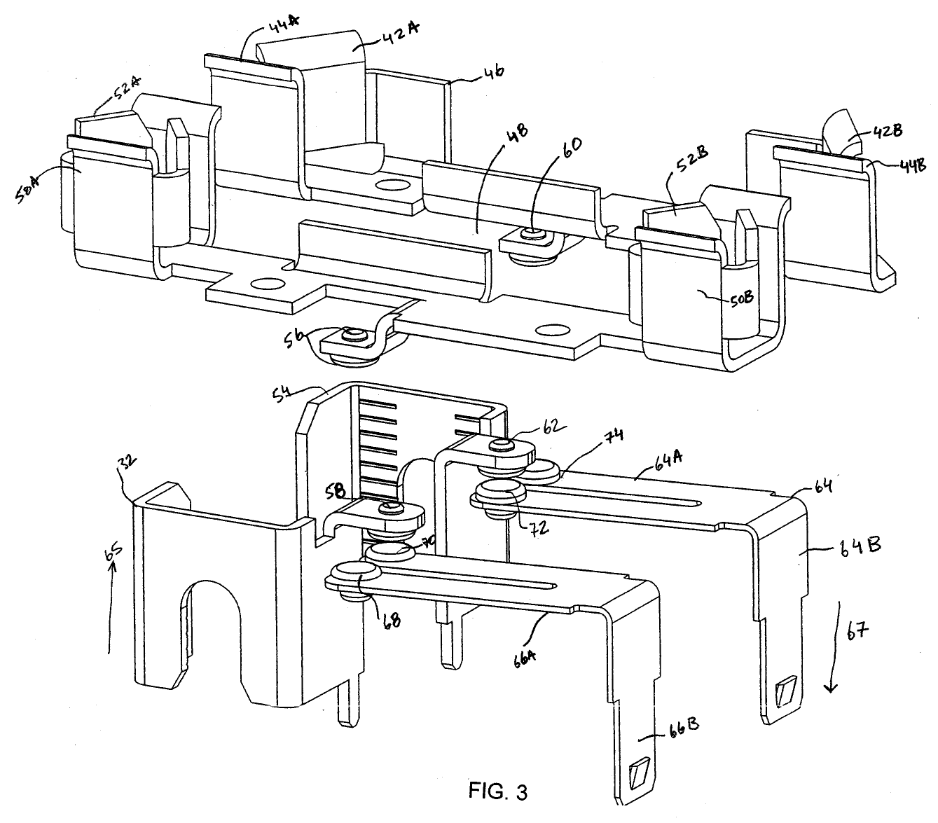

Referring to FIG. 2, a top view of the GFCI device (without face portion 36 and strap 14) is shown. An internal housing structure 40 provides the platform on which the components of the GFCI device are positioned. Reset button 20 and test button 22 are mounted on housing structure 40. Housing structure 40 is mounted on printed circuit board 38. The receptacle aligned to opening 16 of face portion 36 is made from extensions 50A and 52A of frame 48. Frame 48 is made from an electricity conducting material from which the receptacles aligned with openings 16 and 24 are formed. The receptacle aligned with opening 24 of face portion 36 is constructed from extensions 50B and 52B of frame 48. Also, frame 48 has a flange the end of which has electricity conducting contact 56 attached thereto. Frame 46 is an electricity conducting material from which receptacles aligned with openings 18 and 26 are formed. The receptacle aligned with opening 18 of frame portion 36 is constructed with frame extensions 42A and 44A. The receptacle aligned with opening 26 of face portion 36 is constructed with extensions 42B and 44B. Frame 46 has a flange the end of which has electricity conducting contact 60 attached thereto. Therefore, frames 46 and 48 form the face terminals implemented as receptacles aligned to openings 16, 18, 24 and 26 of face portion 36 of GFCI 10 (see FIG. 1). Load terminal 32 and line terminal 34 are also mounted on internal housing structure 40. Load terminal 32 has an extension the end of which electricity conducting load contact 58 is attached. Similarly, load terminal 54 has an extension to which electricity conducting contact 62 is attached. The line, load and face terminals are electrically isolated from each other when the GFCI is in the tripped state. In the reset state, the line, load, and face terminals are electrically connected to each other. This connection can be made in any number of ways and one such example is by a pair of movable bridges. In the present embodiment, the relationship between the line, load and face terminals and how they are connected to each other is shown in FIG. 3.

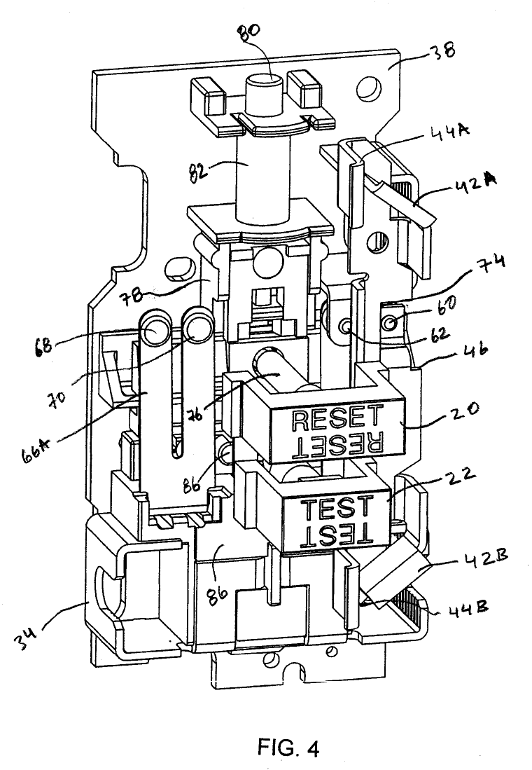

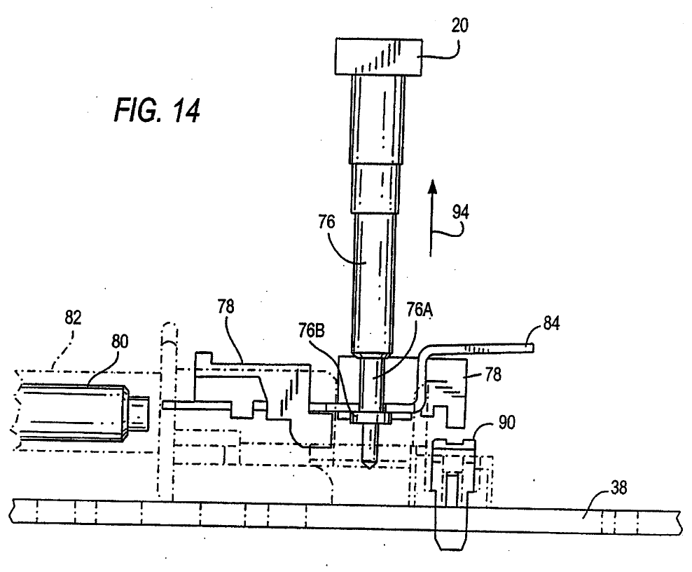

Referring now to FIG. 3, for the present embodiment, there is shown the positioning of the face and load terminals with respect to each other and their interaction with the movable bridges (64, 66). Although the line terminals are not shown, it is understood that they are electrically connected to one end of the movable bridges, in the present embodiment. The movable bridges (64, 66) are generally electrical conductors that are configured and positioned to connect at least the line terminals to the load terminals. In particular movable bridge 66 has bent portion 66B and connecting portion 66A. Bent portion 66B is electrically connected to line terminal 34 (not shown). Similarly, movable bridge 64 has bent portion 64B and connecting portion 64A. Bent portion 64B is electrically connected to the other line terminal (not shown); the other line terminal being located on the side opposite that of line terminal 34. Connecting portion 66A of movable bridge 66 has two fingers each having a bridge contact (68, 70) attached to its end. Connecting portion 64A of movable bridge 64 also has two fingers each of which has a bridge contact (72, 74) attached to its end. The bridge contacts (68, 70, 72 and 74) are made from conductive material. Also, face terminal contacts 56 and 60 are made from conductive material. Further, the load terminal contacts 58 and 62 are made from conductive material. The movable bridges may be preferably made from flexible metal that can be bent when subjected to mechanical forces. However, the moveable bridge may also be constructed in any suitable manner. The connecting portions (64A, 66A) of the movable bridges are mechanically biased downward or in the general direction shown by arrow 67. When the GFCI device is reset, the connecting portions of the movable bridges are caused to move in the direction shown by arrow 65 and engage the load and face terminals thus connecting the line, load and face terminals to each other. In particular connecting portion 66A of movable bridge 66 is bent upward (direction shown by arrow 65) to allow contacts 68 and 70 to engage contacts 56 of frame 48 and contact 58 of load terminal 32 respectively. Similarly, connecting portion 64A of movable bridge 64 is bent upward (direction shown by arrow 65) to allow contacts 72 and 74 to engage contact 62 of load terminal 54 and contact 60 of frame 46 respectively. The connecting portions of the movable bridges are bent upwards by a latch/lifter assembly positioned underneath the connecting portions where this assembly moves in an upward direction (direction shown by arrow 65) when the GFCI is reset as will be discussed herein below with respect to FIG. 14. It should be noted that the contacts of a movable bridge engaging a contact of a load or face terminals occurs when electric current flows between the contacts; this is done by having the contacts touch each other. Some of the components that cause the connecting portions of the movable bridges to move upward in the illustrated preferred embodiment are shown in FIG. 4.

Referring now to the embodiment of FIG. 4, there is shown mounted on printed circuit board 38 a coil plunger combination comprising bobbin 82 having a cavity in which elongated cylindrical plunger 80 is slidably disposed. For clarity of illustration frame 48 and load terminal 32 are not shown. One end of plunger 80 is shown extending outside of the bobbin cavity. The other end of plunger 80 (not shown) is optionally coupled to or engages a spring that provides the proper force for pushing a portion of the plunger outside of the bobbin cavity after the plunger has been pulled into the cavity due to a resulting magnetic force when the coil is energized. Electrical wire (not shown) is wound around bobbin 82 to form the coil. For clarity of illustration the wire wound around bobbin 82 is not shown. A lifter 78 and latch 84 assembly is shown where the lifter 78 is positioned underneath the movable bridges. The movable bridges 66 and 64 are secured with mounting brackets 86 (only one is shown) which is also used to secure line terminal 34 and the other line terminal (not shown) to the GFCI device. It is understood that the other mounting bracket 86 used to secure movable bridge 64 is positioned directly opposite the shown mounting bracket. The reset button 20 has a reset pin 76 that engages lifter 78 and latch 84 assembly as will be shown below.

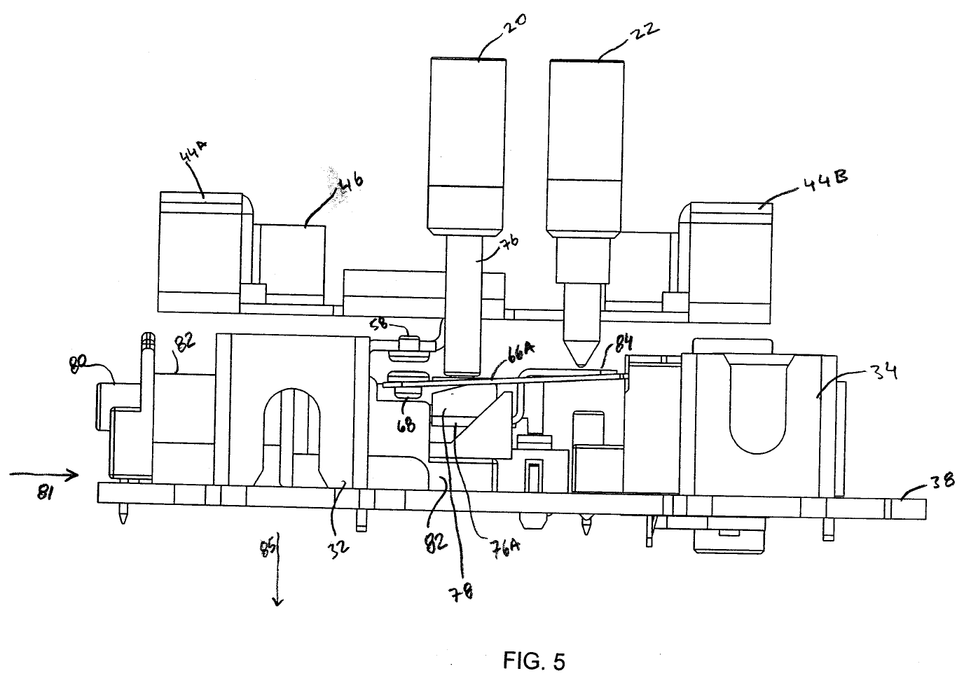

Referring now to FIG. 5, there is shown a side view of FIG. 4. When the coil is energized, plunger 80 is pulled into the coil in the direction shown by arrow 81. Connecting portion 66A of movable bridge 66 is shown biased downward (in the direction shown by arrow 85). Although not shown, connecting portion of movable bridge 64 is similarly biased. Also part of a mechanical switch —test arm 90— is shown positioned under a portion of the lifter 78. It should be noted that because frame 48 is not shown, face terminal contact 56 is also not shown.

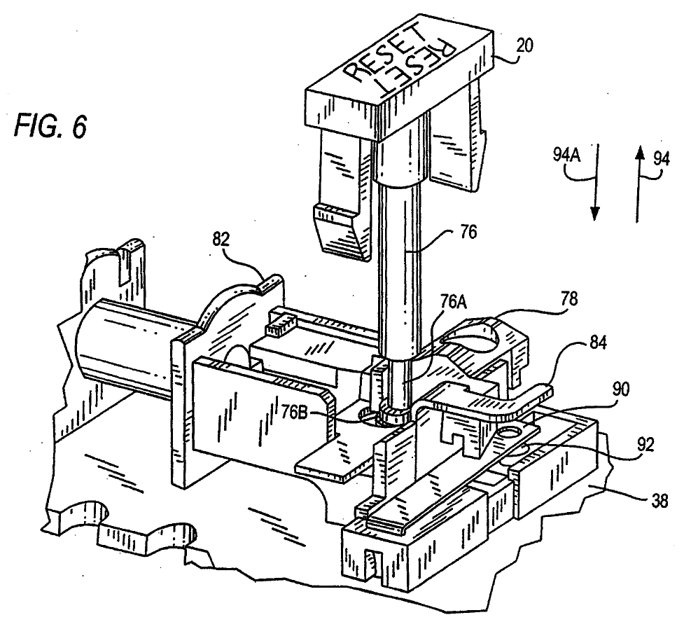

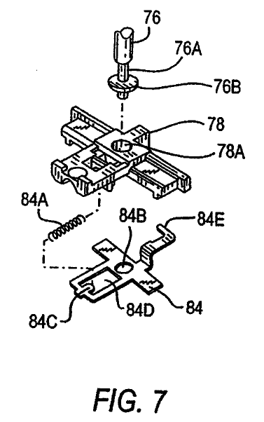

Referring now to FIG. 6, there is shown the positioning of the lifter 78, latch 84 assembly relative to the bobbin 82, the reset button 20 and reset pin 76. Note that the reset pin has a lower portion 76A and a disk shape flange 76B. It should be noted that the flange 76B can be any shape, the disk shape flange shown here is one particular embodiment of the type of flange that can be used. The lower portion 76A of the reset pin and flange 76B are positioned so as to extend through aligned openings of the latch 84 and lifter 78. The mechanical switch assembly is also shown positioned underneath a portion of the lifter 78. The mechanical switch assembly comprises test arm 90 and test pin 92 used to cause a trip condition to occur. The reset button 20 and reset pin 76 are biased with a spring coil (not shown) in the upward direction (direction shown by arrow 94). Test arm 90 of the mechanical switch is also biased upward. When the test arm 90 is pressed downward (direction shown by arrow 94A), it will tend to move upward (direction shown by arrow 94) to its original position when released. Similarly, when reset button 20 is depressed (in the direction shown by arrow 94A), it will tend to return to its original position by moving in the direction shown by arrow 94 when released. Latch plate 84 and lifter 78 assembly are mounted on top of bobbin 82. Only a portion of lifter 78 is shown so as to illustrate how lifter 78 engages test arm 90 and how latch plate 84 engages lifter 78. The specific relationship between latch plate 84 and lifter 78 is shown in FIG. 7.

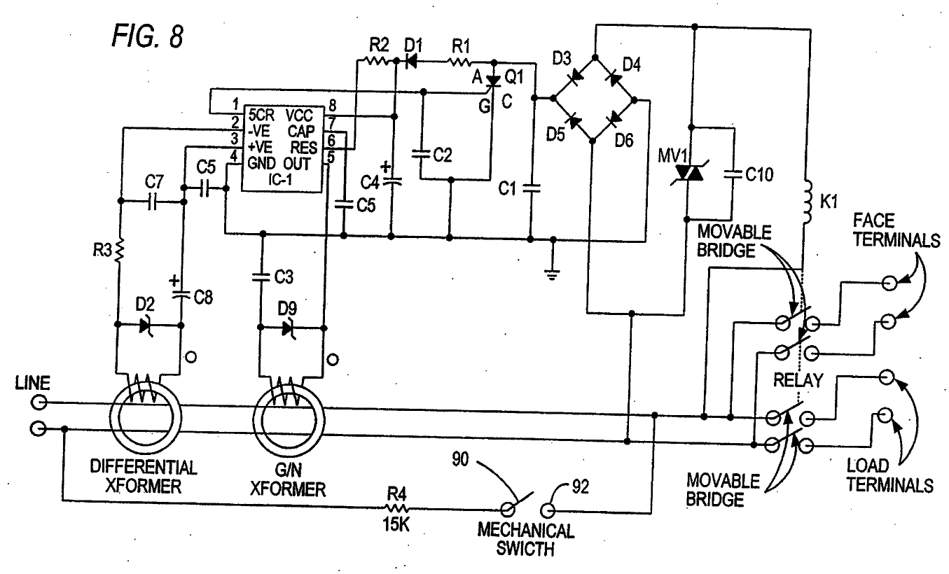

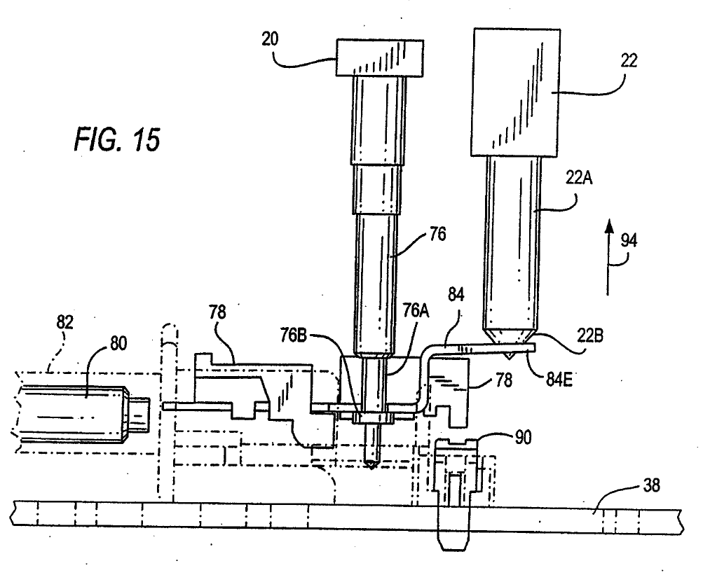

Referring now to FIG. 7, there is shown how the latch plate 84 is slidably and springingly mounted to lifter 78. Latch plate 84 has an opening 84B and another opening 84D within which spring coil 84A is positioned. Latch plate stub 84C is used to receive one end of spring coil 84A and the other end of spring coil 84A engages with a detent portion of lifter 78. Latch plate 84 has a hook portion 84E used to engage test button 22 as will be discussed herein below with respect to FIG. 15. Although not part of the latch plate/lifter assembly, reset pin 76, with lower portion 76A and flange 76B is designed to extend through opening 78A of lifter 78 and opening 84B of latch plate 84 when the two openings are aligned to each other. The two openings become aligned with each other when the plunger 80 of the coil plunger assembly engages latch plate 84 as will be discussed herein. The plunger is caused to be pulled into the cavity of the bobbin 82 when the coil is energized by a sensing circuit when the circuit detects a fault or a predetermined condition. In the embodiment being discussed, the predetermined condition detected is a ground fault. The predetermined condition can be any type of fault such as an arc fault, equipment fault, appliance leakage fault or an immersion detection fault. Additionally, the predetermined condition can be any condition to which the GFCI is designed to respond to. Generally a fault is an indication that the circuit interrupting device has detected a dangerous condition and has or intends to disconnect power from any loads connected to the device via the load terminals and/or the face terminals. In the context of a GFCI, a fault is a circumstance or a set of circumstances whereby a current imbalance, of a particular amplitude and lasting a sufficient length of time, is caused to exist between the phase conductors and the neutral conductors of the GFCI. The imbalance may be detected by the sensing circuit shown in FIG. 8.

Referring now to FIG. 8, in the present embodiment, there is shown a sensing circuit comprising a differential transformer, a Ground/Neutral (G/N) transformer, an integrated circuit (IC-1) for detecting current and outputting a voltage once it detects a current, a full wave bridge rectifier (D3, D4, D5, and D6), a surge suppressor (MV1) for absorbing extreme electrical energy levels that may be present at the line terminals, various filtering coupling capacitors (C1-C9), a gated semiconductor device (Q1), a relay coil assembly (K1), various current limiting resistors (R1-R4) and a voltage limiting zener diode (D2). It should be understood that the components present here are just one implementation of this device and alternate implementations can be used without departing from the spirit of the invention. The mechanical switch—which may comprise test arm 90 and test pin 92—is shown connected to the conductors of the line terminals. The movable bridges are shown as switches that connect the line terminals to the face and load terminals. In the present embodiment, the line, load and face terminals are electrically isolated from each other unless connected by the movable bridges. When a predetermined condition—such as a ground fault—occurs, there is a difference in current amplitude between the two line terminals. This current difference is manifested as a net current which is detected by the differential transformer and is provided to IC-1. Integrated circuit IC-1 can be any one of integrated circuits typically used in ground fault circuits (e.g., LM-1851) manufactured by National Semiconductor or other well known semiconductor manufacturers. Additionally, integrated circuit IC-1 can be any suitable integrated circuit, or other circuit element or elements. In the present embodiment, in response to the current provided by the differential transformer, integrated circuit IC-1 generates a voltage on pin 1 which is connected to the gate of Q1. A full wave bridge comprising diodes D3-D6 has a DC side which is connected to the anode of Q1. Q1 is turned on shorting the DC side of the full wave bridge activating relay K1 causing the movable bridges to remove power from the face and load terminals. The relay K1 may optionally be implemented with the bobbin 82, coil (not shown) and plunger 80 components. Note diode D1 performs a rectification function retaining the supply voltage to IC-1 when Q1 is turned on. The relay K1 can also be activated when mechanical switch 90 is closed which causes a current imbalance on the line terminal conductors that is detected by the differential transformer. The G/N transformer detects a remote ground voltage that may be present on one of the load terminal conductors and provides a current to IC-1 upon detection of this remote ground which again activates relay K1.

The sensing circuit engages a circuit interrupting portion of the GFCI device causing the device to be tripped. Also, the sensing circuit allows the GFCI device to be reset after it has been tripped. If reset lockout is optionally incorporated into the GFCI, the device will not be allowed to reset if the reset lockout has been activated as discussed herein below. In the tripped condition the line terminals, load terminals and face terminals are electrically isolated from each other. Thus, even if the device is reverse wired, there will be no power at the face terminals. A GFCI manufactured in accordance to an embodiment of the present invention may optionally be shipped in the tripped condition. The circuit interrupting portion may comprise the coil and plunger (80) assembly, the latch plate (84) and lifter (78) assembly, and the mechanical switch assembly (90, 92).

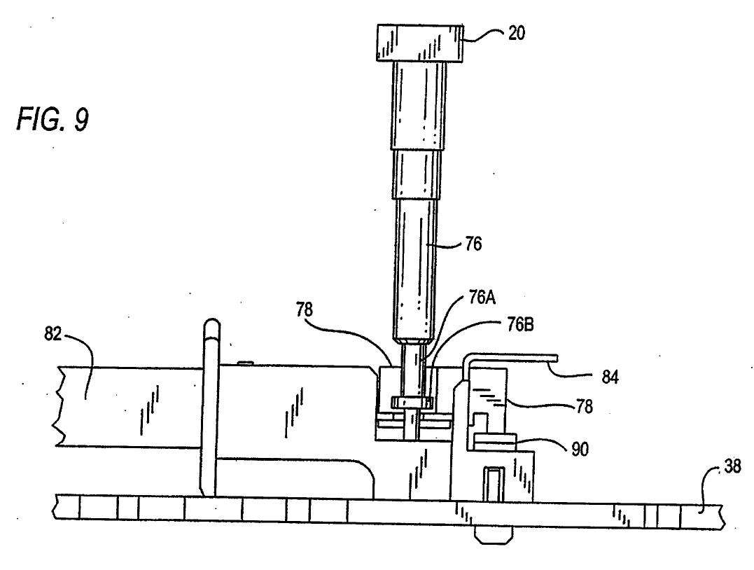

Referring to FIGS. 9-14, there is shown a sequence of how the GFCI is reset from a tripped condition, in the present embodiment. When the GFCI device is in a tripped condition, the line, load and face terminals are electrically isolated from each other because the movable bridges are not engaged to any of the terminals. Referring to FIG. 9 there is shown the positioning of the reset button 20, reset pin 76, reset pin lower portion 76A and disk 76B when the device is in the tripped condition. In the tripped condition, the lifter 78 positioned below the movable bridges (not shown) does not engage the movable bridges. Reset button 20 is in its fully up position. Latch 84 and lifter 78 are such that the openings of the latch 84 and the lifter 78 are misaligned not allowing disk 76B to go through the openings. Also a portion of lifter 78 is positioned directly above test arm 90 but does not engage test arm 90.

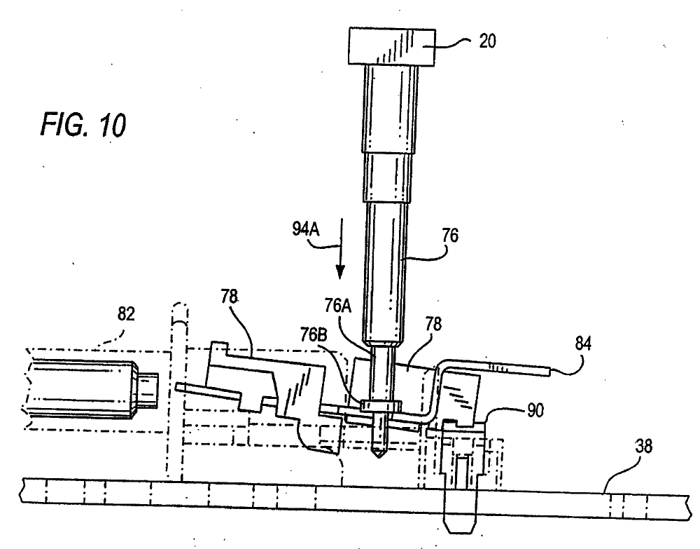

In FIG. 10, to initiate the resetting of the GFCI device, reset button 20 is depressed (in the direction shown by 94A) causing flange 76B to interfere with latch plate 84 as shown which causes lifter 78 to press down on test arm 90 of the mechanical switch. As a result, test arm 90 makes contact with test pin 92 (see FIG. 6).

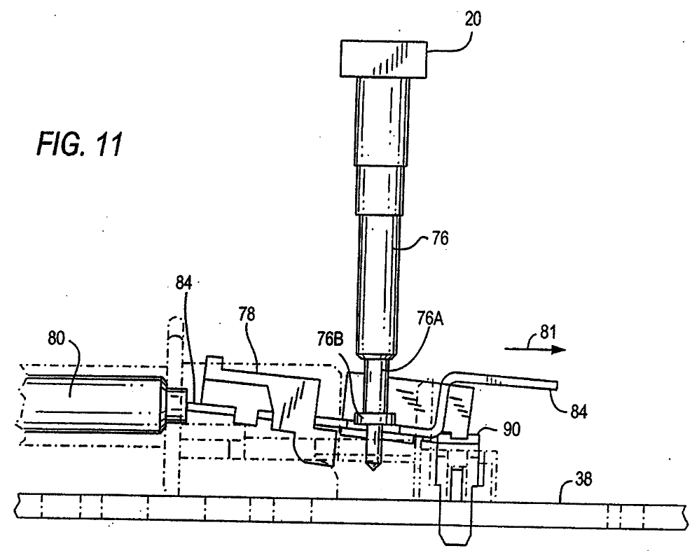

In FIG. 11, when test arm 90 makes contact with test pin 92, the sensing circuit is triggered as explained above, energizing the coil causing plunger 80 to be momentarily pulled into the bobbin 82 engaging latch plate 84 and more specifically pushing momentarily latch plate 84 in the direction shown by arrow 81.

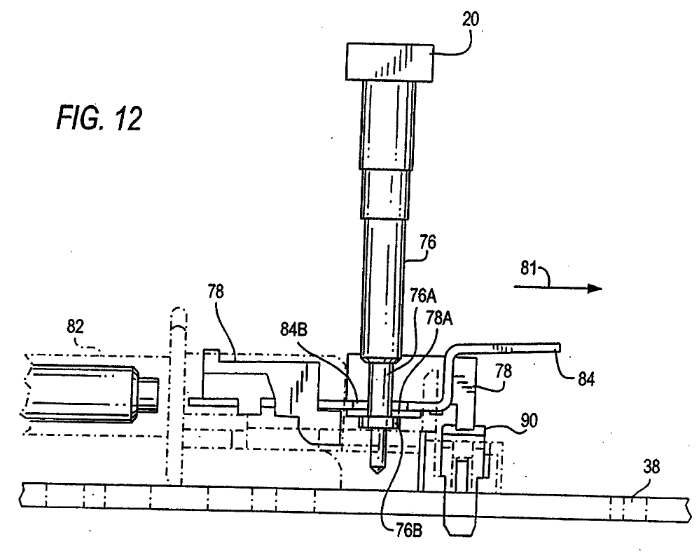

In FIG. 12, the latch plate, when pushed by plunger 80, slides along lifter 78 (in the direction shown by arrow 81) so as to align its opening with the lifter opening allowing flange 76B and part of lower reset pin portion 76A to extend through the openings 84B, 78A (see FIG. 7).

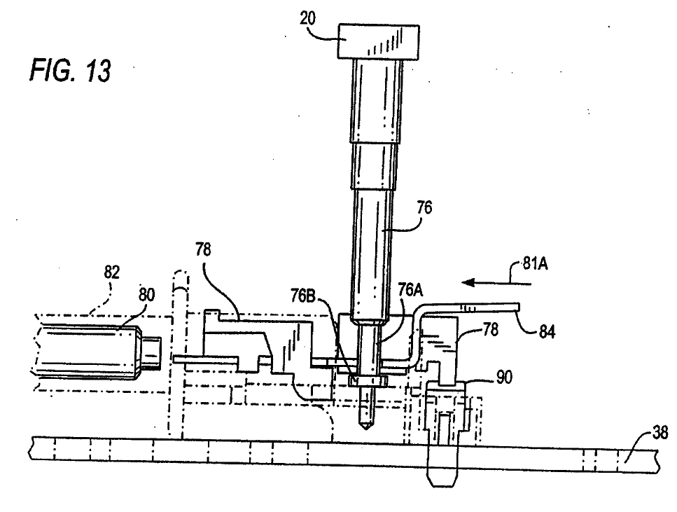

In FIG. 13, the latch plate then recoils back (in the direction shown by arrow 81A) and upon release of the reset button, test arm 90 also springs back disengaging from contact 92 (see FIG. 6). In FIG. 14, the recoiling of the latch plate 84 causes the opening 84B to once again be misaligned with opening 74A thus trapping flange 76B underneath the lifter 78 and latch assembly. When reset button is released the biasing of the reset pin 76 in concert with the trapped flange 76B raise the lifter and latch assembly causing the lifter (located underneath the movable bridges) to engage the movable bridges 66, 64. In particular, the connecting portions (66A, 64A) of the movable bridges 66 and 64 respectively are bent in the direction shown by arrow 65 (see FIG. 3 and corresponding discussion above) resulting in the line terminals, load terminals and face terminals being electrically connected to each other. The GFCI is now in the reset mode meaning that the electrical contacts of the line, load and face terminals are all electrically connected to each other allowing power from the line terminal to be provided to the load and face terminals. The GFCI will remain in the reset mode until the sensing circuit detects a fault or the GFCI is tripped purposely by depressing the test button 22.

When the sensing circuit detects a condition such as a ground fault for a GFCI or other conditions (e.g., arc fault, immersion detection fault, appliance leakage fault, equipment leakage fault), the sensing circuit energizes the coil causing the plunger 80 to engage the latch 84 resulting in the latch opening 84B being aligned with the lifter opening 78A allowing the lower portion of the reset pin 76A and the disk 76B to escape from underneath the lifter causing the lifter to disengage from the movable bridges 64, 66 which, due to their biasing, move away from the face terminals contacts and load terminal contacts. As a result, the line, load and face terminals are electrically isolated from each other and thus the GFCI device is in a tripped state or condition (see FIG. 9).

The GFCI device of an embodiment of the present invention can also enter the tripped state by pressing the test button 22. In FIGS. 15-18, there is illustrated a sequence of operation showing how the device can be tripped using the test button 22. In FIG. 15, while the device is in the reset mode, test button 22 is depressed. Test button 22 has test button pin portion 22A and cam end portion 22B connected thereto and is mechanically biased upward in the direction shown by arrow 94. The cam end portion 22B is preferably conically shaped so that when it engages with the hooked end 84E of latch plate 84 a cam action occurs due to the angle of the end portion of the test button pin 22A.

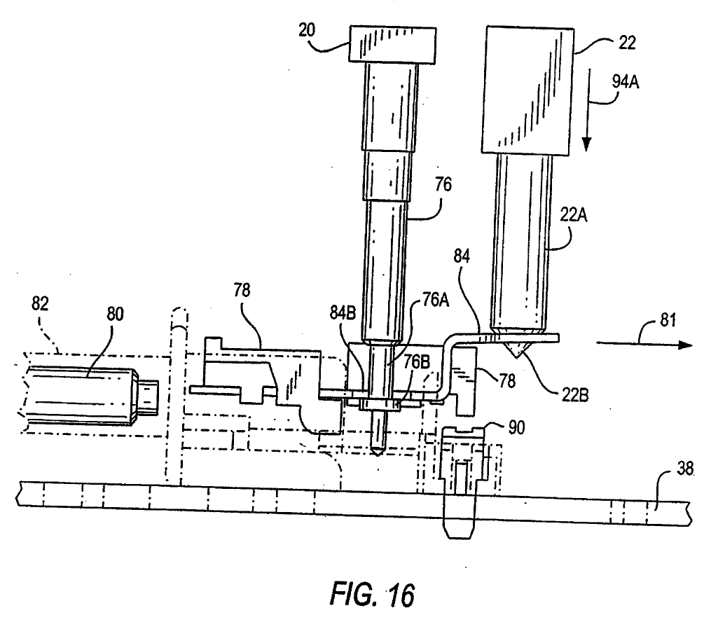

In FIG. 16, the cam action is the movement of latch plate 84 in the direction shown by arrow 81 as test button 22 is pushed down (direction shown by arrow 94A) causing latch plate opening 84B to be aligned with lifter opening 78A.

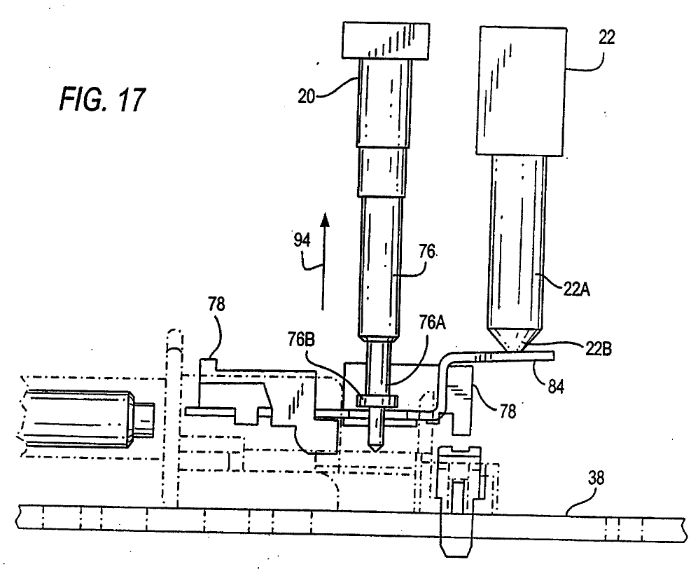

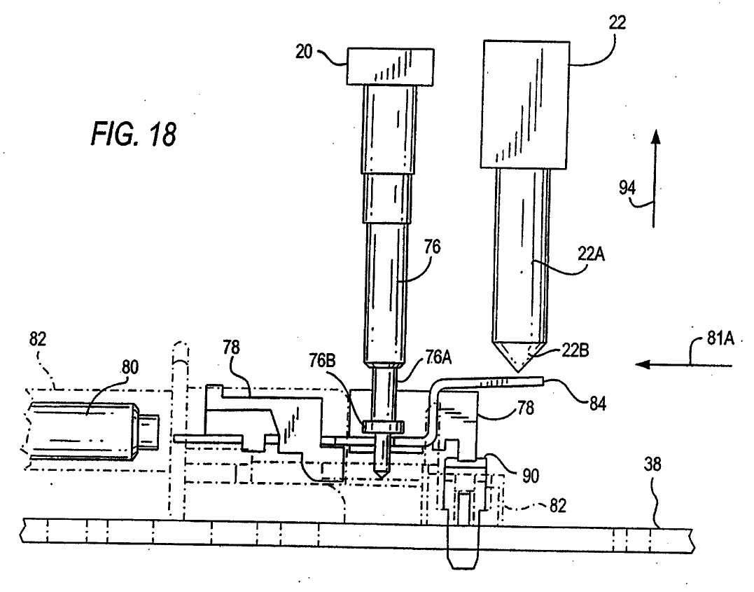

In FIG. 17, the alignment of the openings (78A, 84B) allows the lower portion of the reset pin 76A and the disk 76B to escape from underneath the lifter causing the lifter to disengage from the movable bridges 64, 66 which, due to their biasing, move away from the face terminals contacts and load terminal contacts (see FIG. 3). The test button 20 is now in a fully up position. As a result, the line, load and face terminals are electrically isolated from each other and thus the GFCI device is in a tripped state or condition (see FIG. 9). In FIG. 18, the test button 22 is released allowing its bias to move it upward (direction shown by arrow 94) and disengage from the hook portion 84E of latch plate 84. The latch plate recoils in the direction shown by arrow 81A thus causing the opening in the latch plate 84 to be misaligned with the opening of the lifter 78. The device is now in the tripped position. It should be noted that once the device of an embodiment of the present invention is in a tripped position, depressing the test button will not perform any function because at this point the latch 84 cannot be engaged by the angled end of the test button 22. The test button 22 will perform the trip function after the device has been reset.

The GFCI device of the present embodiment of the invention once in the tripped position will not be allowed to be reset (by pushing the reset button) if the circuit interrupting portion is non-operational; that is if any one or more of the components of the circuit interrupting portion is not operating properly, the device cannot be reset. Further, if the sensing circuit is not operating properly, the device can not be reset. The reset lockout mechanism of the present embodiment of the invention can be implemented in an affirmative manner where one or more components specifically designed for a reset lockout function are arranged so as to prevent the device from being reset if the circuit interrupting portion or if the sensing circuit are not operating properly. The reset lockout mechanism can also be implemented in a passive manner where the device will not enter the reset mode if any one or more of the components of the sensing circuit or if any one or more of the components of the circuit interrupting portion is not operating properly; this passive reset lockout approach is implemented in the present embodiment of the invention. For example, if anyone of the following components is not operating properly or has a malfunction—i.e., the coil/plunger assembly (82, 80) or the latch plate/lifter assembly (84, 78) or the reset button/reset pin (22, 76) the device cannot be reset. Further if the test arm (90) or test pin (92) is not operating properly, the device cannot be reset. In addition, any other condition in which it is desired to prevent the device from resetting, the GFCI can implement reset lockout.

It should be noted that the circuit interrupting device of the present embodiment of the invention may have a trip portion that operates independently of the circuit interrupting portion so that in the event the circuit interrupting portion becomes non-operational the device can still be tripped. Preferably, the trip portion is manually activated as discussed above (by pushing test button 22) and uses mechanical components to break one or more conductive paths. However, the trip portion may use electrical circuitry and/or electromechanical components to break either the phase or neutral conductive path or both paths. Additionally, the trip portion may use any suitable means to break one or more of the conductive paths.

Although the components used during circuit interrupting and device reset operations are electromechanical in nature, the present application also contemplates using electrical components, such as solid state switches and supporting circuitry, as well as other types of components capable or making and breaking electrical continuity in the conductive path.

The circuit interrupting and reset portions described herein preferably use electro-mechanical components to break (open) and make (close) one or more conductive paths between the line and load sides of the device. However, electrical components, such as solid state switches and supporting circuitry, or any other suitable means, may be used to open and close the conductive paths.

Generally, the circuit interrupting portion is used to automatically break electrical continuity in one or more conductive paths (i.e., open the conductive path) between the line and load sides upon the detection of a fault. The reset portion is used to close the open conductive paths.

In the embodiments including a reset lockout, the reset portion is used to disable the reset lockout, in addition to closing the open conductive paths. In this configuration, the operation of the reset and reset lockout portions is in conjunction with the operation of the circuit interrupting portion, so that electrical continuity in open conductive paths cannot be reset if the circuit interrupting portion is non-operational, if an open neutral condition exists and/or if the device is reverse wired.

In the embodiments including an independent trip portion, electrical continuity in one or more conductive paths can be broken independently of the operation of the circuit interrupting portion. Thus, in the event that the circuit interrupting portion is not operating properly, the device can still be tripped.

Having described the various embodiments of the GFCI used in the electrical receptacle of the present invention, a discussion of how the tamper resistant mechanism may cooperate with the GFCI to form an embodiment of the electrical receptacle of an embodiment of the present invention now follows.

II. Electrical Receptacle

The electrical receptacle in accordance with an embodiment of the present invention having a tamper resistant shutter that adds child safety protection is in compliance with the NEC requirement, in general, and the proposed 2008 NEC requirement, in particular. The proposed 2008 NEC requirement requires that all new receptacles installed be of the tamper resistant type. In addition to requiring tamper resistance as a feature for receptacles, the proposed requirement applies to electrical receptacles. Each of the above-described features may be incorporated in any resettable circuit interrupting device in accordance with the present invention, but for simplicity of explanation the following descriptions herein are directed to GFCI receptacles.

In addition to the tamper resistant shutters providing the function of adding child safety protection to a receptacle, the tamper resistant shutter of the present embodiment provides a second function—not allowing the device to be used when the device is tripped. On initial shipment, the receptacle in accordance with the preferred embodiment of the present invention may be shipped in the tripped state in order to facilitate checking for reverse wiring. In particular, a pivoting “locking bar” may be positioned such that, when the GFCI is in the tripped state, the bar blocks the movement of the tamper resistant shutters; the electrical receptacle is thus in a locked position. In this locked position, even if an electrical plug having prongs were properly inserted into the apertures of the receptacle's cover, these prongs would be prevented from making contact with the Phase and Neutral contacts of the receptacle, i.e., the prongs would be blocked by the shutters. When a receptacle configured in accordance with the preferred embodiment of the present invention is properly installed or wired, the receptacle is reset with the use of a lifter that closes the contacts connecting the line terminals of the receptacle to the load and face terminals of the receptacle. Specifically, the upward motion of the lifter can also be used to force a mechanical arm, which is connected to the center of the pivoting locking rod, to also move upward. This upward motion of the mechanical arm causes the pivoting locking bar to pivot downward out of each slot in the tamper resistant shutters. Specifically, the center of the locking rod may sit between two fulcrums such that when the center of the locking rod is pushed upwards, the two ends of the locking rod pivot downwards. As a result, the two ends of the locking bar move out of a slot in each of the tamper resistant shutters. In the preferred embodiment there is a tamper resistant shutter for each outlet. In a dual receptacle, there is one shutter for the top outlet and one for the bottom outlet. However, the present invention is not limited to a two shutter arrangement. Whether the receptacle has one or more shutters, the invention requires a locking bar that is released when power is applied to the line side of the receptacle. When the two ends of the locking bar are clear from the two shutters, the shutters are free to move laterally if an electrical plug having prongs is properly inserted into the outlet. The end result is that the pivoting locking bar does not block the movement of the tamper resistant shutters and the receptacle is placed in an unlocked position allowing a user to insert a plug with prongs in the entry ports of the electrical receptacle when the prongs make electrical contact with the face terminals.

While the description above discusses the operation of the locking bar in connection with the circuit interruption mechanism described above, it should be noted that this is a description of only the embodiment described. Specifically, the tamper resistant shutters can be locked in place, blocking access to the receptacle, or receptacles, in response to the device being reversed wired, regardless of the specific circuit interrupter construction. By way of example, if the GFCI is in the tripped state, and voltage is detected across the load terminals, an actuator could ensure that the locking bar is put into, or remains, in the locked position.

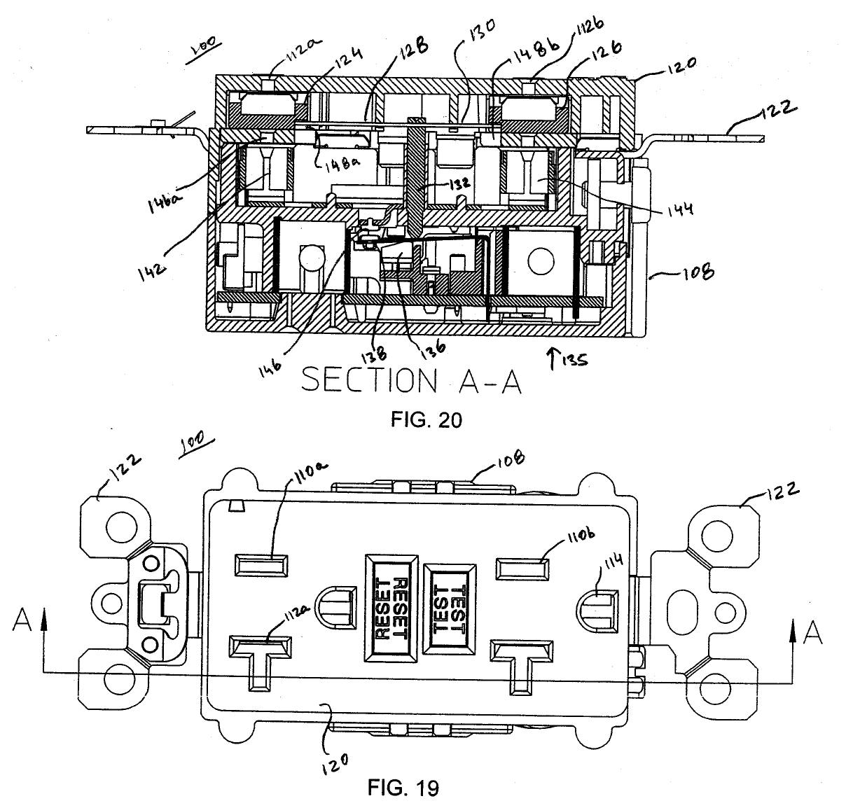

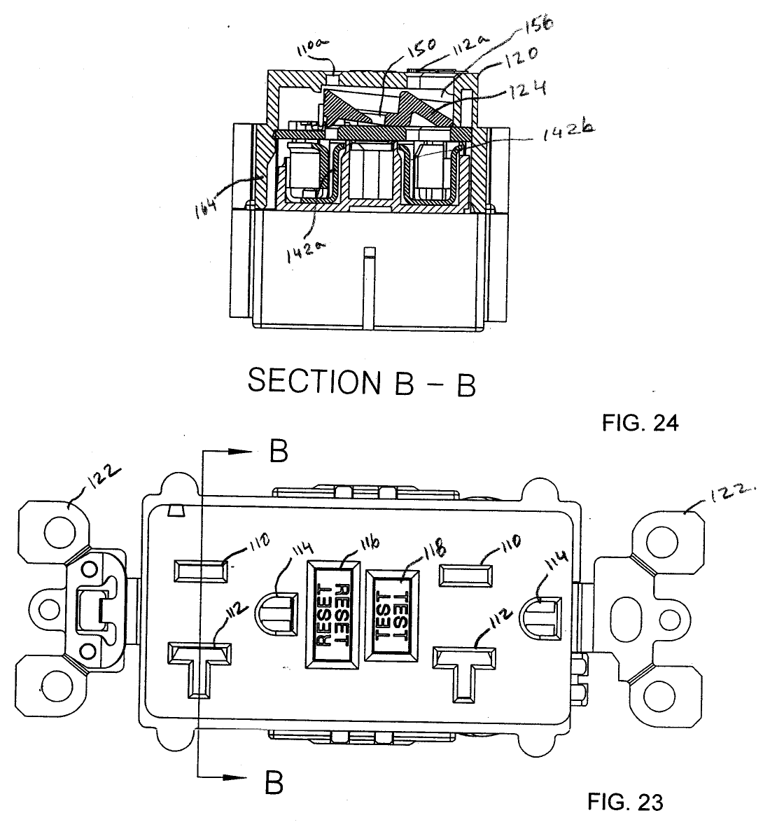

FIGS. 19-22A illustrate the operation of the electrical receptacle having a GFCI and tamper resistant shutters disposed therein in accordance with the illustrated preferred embodiment of the present invention; while FIGS. 23-29 display the mechanical operation of tamper resistant shutters for child protection. Although similar in appearance, the GFCI receptacle described above with respect to FIGS. 1-18 does not have a tamper resistant mechanism disposed therein; the electrical receptacle appearing in FIGS. 19-29 does have a tamper resistant mechanism. The GFCI itself, that is the circuit interrupting device described above (FIGS. 1-18) operates in substantially the same manner and is configured substantially the same as the GFCI disposed in the housing of the electrical receptacle of the present invention. In the interest of avoiding confusion, however, corresponding components of the GFCI receptacle of the present invention, FIGS. 19-29, will be labeled with different reference numerals.

Turning now to FIG. 19, the electrical receptacle 100 has a face or cover portion 120. The face portion 120 has entry ports 110 and 112 for receiving normal or polarized prongs of a male plug of the type normally found at the end of an electrical appliance (e.g., a lamp) or appliance cord set (not shown), as well as ground-prong-receiving openings 114 to accommodate a three-wire plug. The receptacle also includes a mounting strap 122 used to fasten the receptacle to a junction box. Face or cover portion 120 is mounted on housing 108. Optionally, the face portion may be an integral part of the housing. In addition, while FIG. 19 shows a particular NEMA receptacle configuration, the receptacle can be provided with any given configuration required by the user.

A test button 118 may extend through opening 119 in the face portion 120. The test button 118 may be used to activate a test operation, that tests the operation of the circuit interrupting device disposed in the housing 108. Optionally, the test operation may test for any desired condition. The circuit interrupting portion, to be described in more detail below, is used to break electrical continuity in one or more conductive paths between the line and load side of the device. A reset button 116 which may form a part of the reset portion may extend through opening 117 in the face portion 120. The reset button may be used to activate a reset operation, which reestablishes electrical continuity in the open conductive paths.

FIG. 20 represents a cross-section view of FIG. 19 taken along Section line A-A where the cut extends through receptacle 100 wherein the pivoting locking rod comprising sections 128, 130 is in the locked position. Section line A-A extends through receptacle 100 across entry ports 112a and 112b. As shown in FIG. 20, the face or cover portion 120 has entry ports 112a and 112b aligned with tamper resistant shutters 124 and 126, respectively. During normal operation, when a pair of normal or polarized prongs of a male plug of the type normally found at the end of a lamp or appliance cord set (not shown) are inserted in entry port 112a, shutter 124 shifts to enable the prong to pass through aperture 146a making contact with receptacle terminals 142, wherein entry port 112a aligns with shutter 124. Similarly, the pair of prongs may be inserted in entry port 112b, such that shutter 126 shifts to enable the prongs to pass through aperture 146b making contact with receptacle (or face) terminal 144. Normal operation, however, is hindered in the locked position where the ends of the pivoting locking bar sections 128, 130 are positioned in slots 148a and 148b of tamper resistant shutters 124 and 126, respectively. It is in this locking position that receptacle 100 may be shipped to ensure that reverse wiring is prevented or corrected during installation of the unit. The GFCI receptacle is in the tripped condition as contact 140 is disconnected (or is not making contact with) contact 138. In the present embodiment, contact 138 may be mounted on movable bridge 134. Contact 140 is mounted on part of the conductive path for one of the load terminals. It will be understood that the other contacts for the line, load and face terminals (although not shown in FIG. 20) are positioned in similar fashion with respect to each other such that when the GFCI receptacle is in the tripped condition, the line, load and face terminals are electrically isolated from each other.

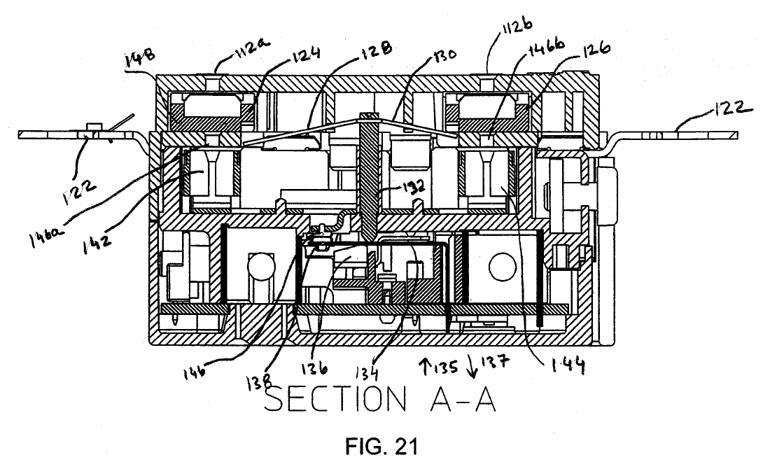

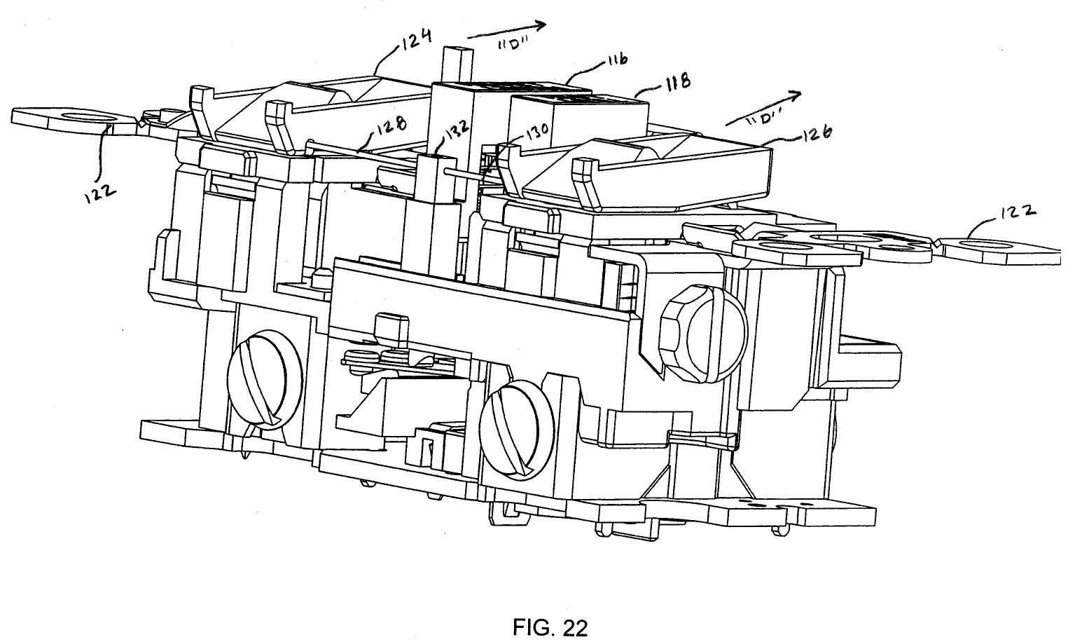

Responsive to a correctly wired receptacle 100 that is reset, (i.e., reset button is depressed) lifter 136 shifts upward (i.e., in the direction shown by arrow 135) making contact with movable bridge 134. Thus, in operation as shown in FIG. 21, if the receptacle 100 is wired correctly, lifter 136 responds to a reset operation in the GFCI, by shifting in the direction shown by arrow 135 and making contact with movable bridge 134. Accordingly, contact 138 mounted on movable bridge 134 is shifted in the direction shown by arrow 135 to meet contact 140. When contacts 138 and 140 are engaged, the receptacle is reset. It should be understood that only one set of contacts are shown for case of explanation; in a typical GFCI two or three sets of contacts mate with each other to reset the device. In this case, as lifter 136 moves in the direction shown by arrow 135 enabling the receptacle to be reset, mechanical arm 132 shifts in the same direction pivoting the sections 128 and 130 of the locking rod. Each respective end of each of the sections 128, 130 of the pivoting locking rod pivots downwards (in the direction shown by arrow 137) out of each slot 148 in each respective tamper resistant shutter 124, 126.

Until receptacle 100 is correctly wired, receptacle 100 will remain in the locked position shown in FIG. 20. In particular, the mechanical arm 132 remains in this locked position wherein each end of the pivoting locking bar sections 128, 30 sits in each respective slot 148a, 148b of the tamper resistant shutters, 124 and 126. Effectively, the use of receptacle 100 is disabled until the receptacle 100 is wired correctly and reset.

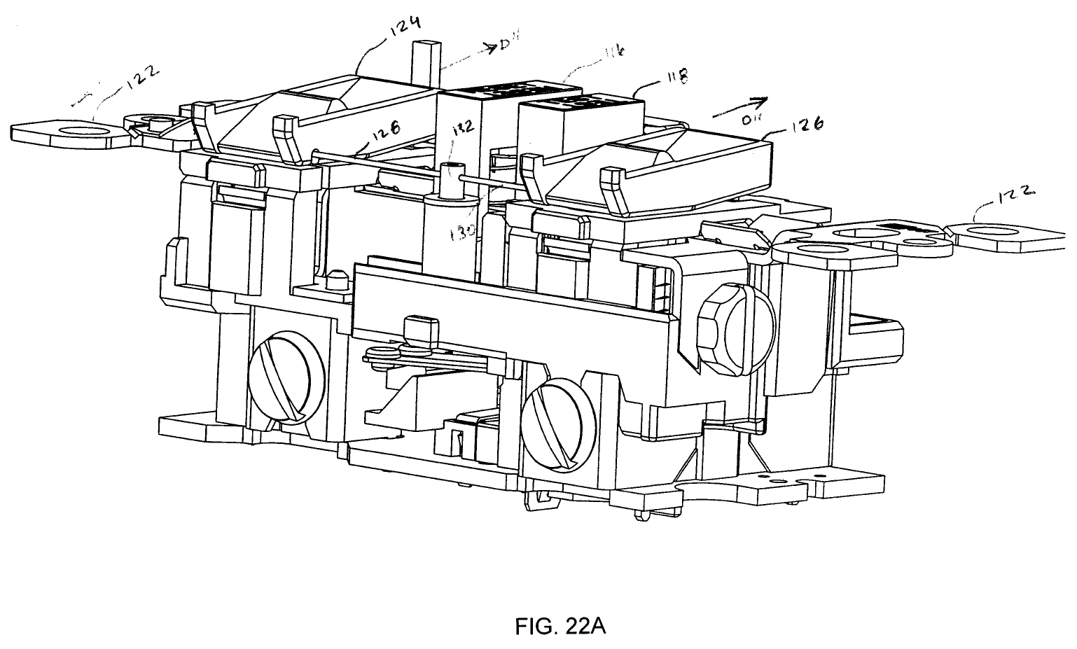

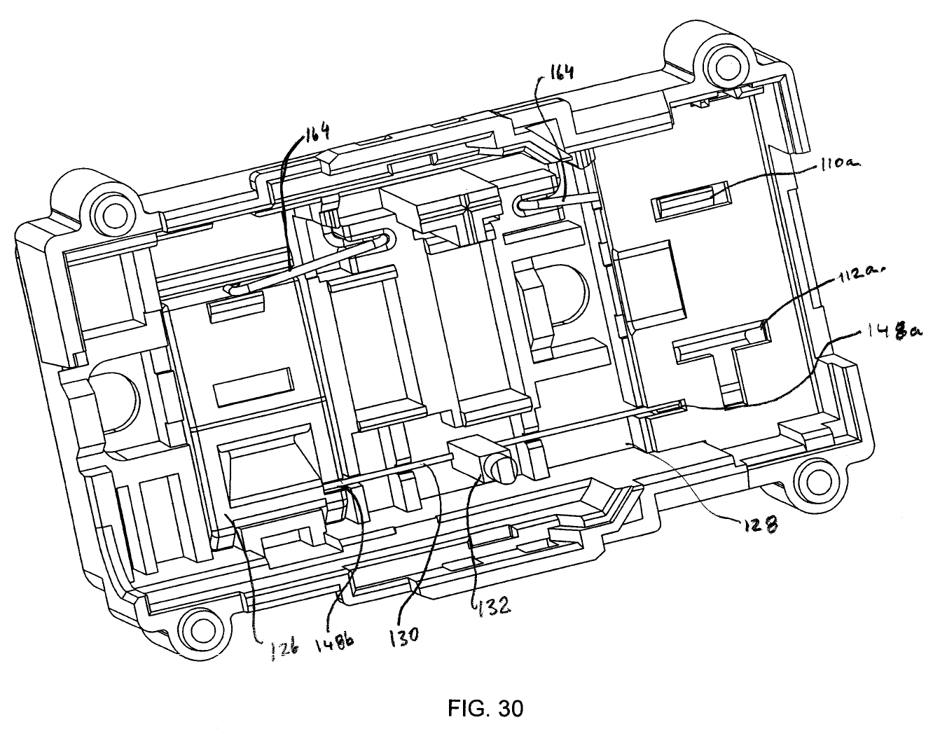

FIG. 22 represents a perspective view of the electrical receptacle 100 in accordance with the preferred embodiment of the present invention having the cover removed, wherein the receptacle 100 is in the locked position. As shown mechanical arm 132 is in the locked position, wherein each end of the pivoting locking rod sections 128, 130 is held in each respective slot (148a, 148b) of the tamper resistant shutters, 124 and 126. With the pivoting locking bar sections 128, 130 in the position shown, the shutters, 124 and 126, are prevented from sliding in the direction shown by arrow “D” when a plug is inserted in either set of entry ports. FIG. 30 shows the underside view of FIG. 22. For ease of illustration shutter 124 is not shown. However, shutter 126 is shown and the manner in which the end of pivoting locking rod section 130 fits into slot 148b. Also, slots 148a and 148b also include slots made in the housing structure and not only the shutters; this is shown in the way pivoting locking rod 128 fits into slot 148a. Also shown are springs 164 that bias the shutters 126 and 126 respectively.

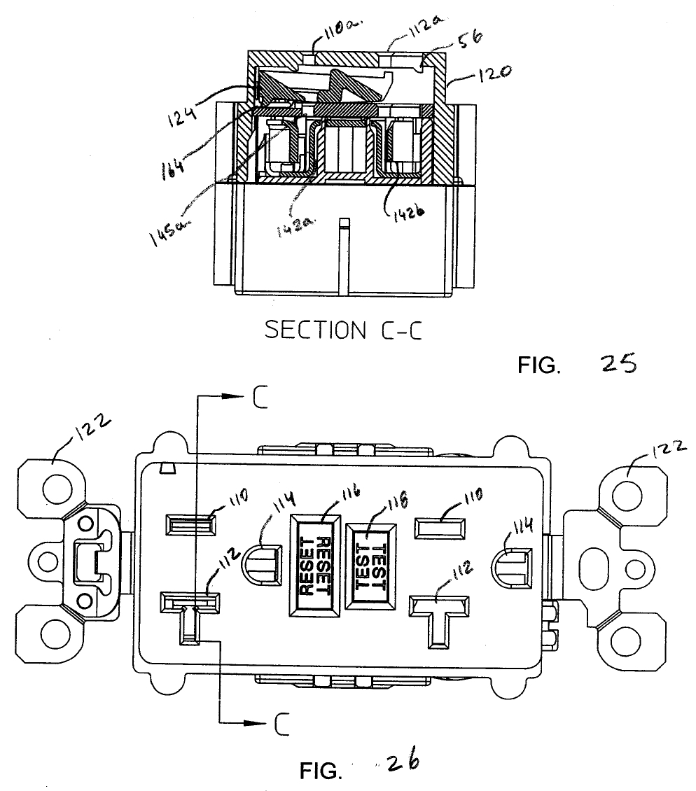

FIG. 23 illustrates the same receptacle 100 of FIG. 19 having section line B-B which extends through the center of entry points 110 and 112. FIG. 24 is the corresponding cross-section view of FIG. 23 taken along Section line B-B where the cut extends through receptacle 100 when the pivoting locking bar is in the locked position. As shown tamper resistant shutter 24 includes an aperture 50 that aligns with entry port 110a and aperture 145a when the shutter is in the unlocked position as shown in FIG. 25. In FIG. 24, however, spring 164 is biased to keep shutter 124 in the position shown. Shutter 124 will shift in the direction shown by arrow “F” when a pair of prongs inserted in apertures 110a and 112a overcomes the bias force of spring 164 to make contact with receptacle terminals 142a and 142b and the electrical receptacle has been reset. Effectively, during installation or at any time when the receptacle 100 is reversed wired and tripped, the receptacle 100 cannot be used by a user due to the assembly of the pivoting locking rod sections 128, 130 and the tamper resistant shutters 124 and 126.

FIG. 26 displays a cross-section view of FIG. 25 taken along Section line C-C where the cut extends through receptacle 100 when the pivoting locking bar is in the unlocked position. Specifically, prongs (not shown) have been inserted in entry ports 110a, 112a overcoming the bias of spring 164 causing said spring to be shifted by the sliding shutter 124 which is caused to slide by the insertion of the prongs. As shown, entry port 110a, and apertures 150, and 145a align to enable a prong inserted in aperture 110a to pass through the tamper resistant shutter 124 at aperture 150 and make contact with receptacle terminal 142a. In addition, a second prong may simultaneously pass through apertures 112a and 146a to make contact with receptacle terminal 142b.

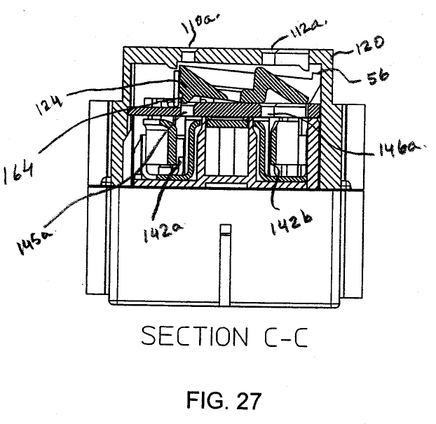

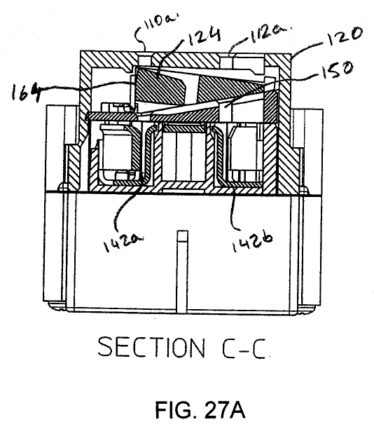

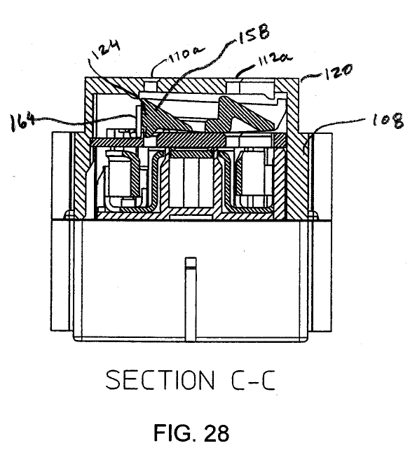

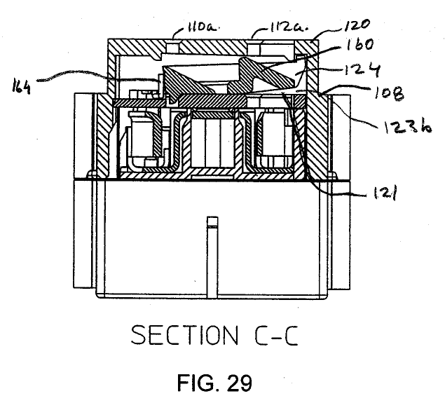

FIG. 25 illustrates the same receptacle 100 of FIG. 19 having cut line C-C. FIG. 27 displays a cross-section view of FIG. 26 taken along Section line C-C where the cut extends through the cover 120 without cutting shutter 124 with the pivoting locking rod sections in the locked position. Specifically, tamper resistant shutter 124 having projections 158, 160, and 162 sits inside cover 120 under entry ports 110a and 112a. Spring 164 biases tamper resistant shutter 124 into a locked position; shutter 124 is kept from moving out of the locked position by one of the sections (section 124; see FIG. 22) of the pivoting locking rod. FIG. 27A is a view of the device in FIG. 27 in accordance with another embodiment of the device where an additional ramp element is added to decrease the angle on the shutter such that the shutter is supported on an angled platform as opposed to a flat platform. FIG. 28 shows a cross-section view of FIG. 26 taken along Section line C-C where the cut extends through the cover 120 without cutting shutter 124 when the pivoting locking rod is in the locked position and where an electrical prong (not shown) is inserted causing the shutter 124 to tilt in a direction shown by arrow 125. When an object probes aperture 110a without probing aperture 112a, tamper resistant shutter 124 tilts in the direction shown by arrow 125 down and does not shift out of the locked position since spring 164 holds shutter 124 in the locked position. FIG. 29 displays a cross-section view of FIG. 26 taken along Section line C-C where the cut extends through the cover 120 without cutting shutter 124 when the pivoting locking rod is in the locked position and wherein an electrical prong (not shown) is inserted causing the shutter 124 to tilt fully. More particularly, when the same object is inserted further through entry port 110a, the projection 156 on the interior surface of cover 120 catches the projection 162 of shutter 124 such that shutter 124 remains in the locked position. Shutter 124 tilts as described when probed at one point near projection 158 because a part 123a of its bottom portion 123 is raised with respect to surface 121 of housing 108. Part 123b of bottom portion 123 is also raised with respect to surface 121, but to a different extent than part 123a. As a result shutter 124 is able to tilt when only one of the entry ports (110a, 112a) is probed. Shutter 126 is configured and operates in substantially the same manner as shutter 124.

Those of skill in the art will recognize that the physical location of the elements illustrated in FIGS. 19-23 can be moved or relocated while retaining the function described above. For example, in another embodiment of a receptacle in accordance with the present invention, the mechanical arm is replaced by a solenoid which differs from the existing trip solenoid incorporated in the design of a GFCI (see FIG. 22A). This solenoid is activated by the GFCI circuitry instead of the mechanical movement of the lifter. Other embodiments may incorporate, but are not limited to, a spring, muscle wire, etc. for substitution of the mechanical arm.

Advantages of this design include but are not limited to an electrical receptacle having an circuit interrupter which is tamper resistant and enabled to detect and prevent reverse wiring. The electrical receptacle in accordance with the present invention includes a high performance, simple, and cost effective design.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

We claim:

1. A wiring device in the form of an electrical receptacle comprising:
a face with one or more openings to receive a plug,
a shutter with an opening and an edge, said shutter disposed behind said face having an open position and a blocking position,
where said blocking position of said shutter is such that said opening in said shutter and said edge of said shutter are misaligned with said openings on said face on said receptacle such that a plug is prevented from being inserted into the receptacle,
where said open position of said shutter is such that said opening in said shutter and said edge of said shutter are aligned with said openings on said face of said receptacle such that a plug is allowed to be inserted into the receptacle
a biasing member to urge said shutter into said blocking position,
a first angled surface disposed adjacent to said opening in said shutter,
a second angled surface disposed adjacent to said edge of said shutter,
such that upon insertion of a plug into the receptacle, the blades of said plug will make contact with said first and second angled surfaces and urge said shutter to said open position against said bias member,
wherein the shutter has a bottom surface comprising
a first portion which is slightly angled upwards,
a second portion which is slightly angled upwards and is disposed adjacent to said first portion such that
when an object other than a mating plug is inserted into the receptacle, the shutter will rock about the juncture of said first portion and said second portion,
said shutter having at least one protrusion,
said housing of said receptacle having at least one shoulder disposed adjacent to said shutter such that when said shutter rocks said at least one protrusion interferes with said at least one shoulder such that said shutter is prevented from moving into said open position.

2. The electrical receptacle of claim 1 wherein said shutter is supported on a surface of ramped member,
such that when said plug is inserted into said receptacle, said shutter is displaced in said direction of plug insertion before being displaced from said blocked position to said unblocked position.

3. The electrical receptacle of claim 2 wherein said surface of a ramped member has a profile such that when an object other than a mating plug is inserted in the receptacle, said shutter will rock about said juncture and will not be displaced in the direction of the plug insertion.

4. The electrical receptacle of claim 1 wherein said electrical receptacle comprises a GFCI.

5. An electrical receptacle comprising:
an electrical receptacle that provides circuit interruption protection having at least one face terminal and at least one set of line terminals for connecting said receptacle to a source of power
at least one shutter that controls access to the at least one face terminal;
a locking mechanism for securing said at least one shutter in a fixed position if the receptacle is not wired with a power source to its line terminals.

6. An electrical receptacle according to claim 5 further comprising a tamper resistant mechanism comprising:
a mechanical arm;
a rod coupled to the mechanical arm;
at least one shutter slidably mounted to a surface and positioned to engage the rod whereby sliding movement of the at least one shutter is prevented or allowed by the rod based on at least one position of the mechanical arm relative to the rod.

7. A receptacle according to claim 6 such that when the circuit interrupting protection does not provide power to said receptacle, said sliding movement of said at least one shutter is prevented.

8. A receptacle according to claim 7 where said mechanical arm is displaced directly by the circuit interrupting protection.

9. A receptacle according to claim 7 where said mechanical arm is displaced by a solenoid.

10. An electrical receptacle according to claim 5 further comprising:
a face with one or more openings to receive a plug,
the shutter with an opening and an edge, said shutter disposed behind said face having an open position and a blocking position,
where said blocking position of said shutter is such that said opening in said shutter and said edge of said shutter are misaligned with said openings on said face on said receptacle such that a plug is prevented from being inserted into the receptacle,
where said open position of said shutter is such that said opening in said shutter and said edge of said shutter are aligned with said openings on said face of said receptacle such that a plug is allowed to be inserted into the receptacle
a biasing member to urge said shutter into said blocking position,
a first angled surface disposed adjacent to said opening in said shutter,
a second angled surface disposed adjacent to said edge of said shutter,
such that upon insertion of a plug into the receptacle, the blades of said plug will make contact with said first and second angled surfaces and urge said shutter to said open position against said bias member,
wherein the shutter has a bottom surface comprising
a first portion which is slightly angled upwards,
a second portion which is slightly angled upwards and is disposed adjacent to said first portion such that
when an object other than a mating plug is inserted into the receptacle, the shutter will rock about the juncture of said first portion and said second portion,
said shutter having at least one protrusion,
said housing of said receptacle having at least one shoulder disposed adjacent to said shutter such that when said shutter rocks said at least one protrusion interferes with said at least one shoulder such that said shutter is prevented from moving into said open position.

11. A electrical receptacle with at least two blade openings with a shutter inside a housing for child protection comprising:
a shutter, said shutter rests on a support surface
said support surface has a wall
said shutter has a bottom flat portion and a bottom angled portion adjacent to bottom flat portion
said bottom angled portion having an angle with respect to bottom flat portion
a first ramp disposed below one blade opening having an angle with respect to said bottom flat portion
second ramp dispose below a second blade opening having an angle with respect to said bottom flat portion
at least one tab
such that
when a plug blade is not inserted in said blade opening above said first ramp, and
when an object is inserted into said blade opening above said second ramp, said tab is disposed adjacent to said wall on said support surface such that said shutter is prevented from moving laterally.

12. The electrical receptacle of claim 11 wherein the shutter further comprises a second tab, said housing has a shoulder such that when a plug blade is not inserted in said blade opening above said first ramp, and
when a plug blade is inserted into said blade opening above said second ramp,
said second tab is disposed adjacent to shoulder of said housing such that said shutter is prevented from moving laterally.

13. The electrical receptacle of claim 11 wherein said shutter further comprises a side wall adjacent to said second ramp, and
said housing has a shoulder such that when a plug blade is inserted in said blade opening above said first ramp, and
when an object is not inserted into said blade opening above said second ramp,
said wall adjacent to said second ramp is disposed adjacent to said shoulder of said housing such that said shutter is prevented from moving laterally.

14. The electrical receptacle of claim 11 wherein
when a plug blade is inserted in said blade opening above said first ramp, and
when a plug blade is inserted into said blade opening above said second ramp,
said second tab is not disposed adjacent to said wall on said support surface such that said shutter is not prevented from moving laterally.

15. The electrical receptacle of claim 11 wherein
said angle between said first ramp and said bottom flat member is between 31.5 and 32.5 degrees,
said angle between said second ramp and said bottom flat member is between 32.5 and 33.5 degrees,
said angle between said bottom angled member and said bottom flat member is between 6.5 and 7.5 degrees.

16. The electrical receptacle of claim 15 wherein
said angle between said first ramp and said bottom flat member is 32 degrees,
said angle between said second ramp and said bottom flat member is 33 degrees,
said angle between said bottom angled member and said bottom flat member is 7 degrees.
